(19) United States
(12) Patent Application Publication
(10) Pub. No.: US 2024/0298634 A1
(43) Pub. Date: Sep. 12, 2024

(54) AQUEOUS DISPERSIONS INCLUDING POLYMER PARTICLES

(71) Applicant: NORTH CAROLINA STATE UNIVERSITY, Raleigh, NC (US)

(72) Inventors: Anurodh Tripathi, Raleigh, NC (US); Tahira Pirzada, Raleigh, NC (US); Barbara Vasconcelos de Farias, Raleigh, NC (US); Saad A. Khan, Raleigh, NC (US); Reny Mathew, Raleigh, NC (US); Charles H. Opperman, Raleigh, NC (US)

(21) Appl. No.: 17/637,022

(22) PCT Filed: Aug. 27, 2020
(86) PCT No.: PCT/US2020/048216

§ 371 Date: Feb. 21, 2022

Related U.S. Application Data
(60) Provisional application No. 62/892,198, filed on Aug. 27, 2019.

(51) Int. Cl. A01N 25/10; A01N 25/04; A01N 43/40; A01P 3/00; A01P 7/04

(52) U.S. Cl. CPC A01N 25/10; A01N 25/04; A01N 43/40; A01P 3/00; A01P 7/04

(57) ABSTRACT

Suspensions include an aqueous medium and a plurality of particles. The particles include polymeric carrier material dispersed throughout the particle and active ingredient dispersed throughout the particle. The polymeric carrier material can be biodegradable, and one example is a cellulose ester. Exemplary active ingredients include an insecticide, a fungicide, and a pesticide. In some instances, the plurality of particles have an average diameter of 25 nm to 5 μm. Exemplary suspensions may be applied to plant surfaces.

### CROSS-REFERENCE TO RELATED APPLICATION(S)

The present application is related to and claims the priority benefit of U.S. Provisional Patent Application No. 62/892,198, filed Aug. 27, 2019, the entire contents of which are incorporated herein by reference.

### TECHNICAL FIELD

The present disclosure relates to aqueous dispersions including polymer particles. More particularly, systems and methods disclosed and contemplated herein involve generation of aqueous dispersions with particles that include polymeric carrier material and active ingredient.

### INTRODUCTION

Fungi, pests, and insects pose a threat worldwide to a variety of crops. Significant investment of resources is devoted annually to address crop protection at the roots and leaves, yet challenges remain. One example threat is Black Sigatoka, which is a fungal leaf spot disease caused by Pseudocercospora fijiensis. Black Sigatoka is one of the most significant fungal pathogens that attacks vulnerable banana and plantain leaves.

### SUMMARY

The instant disclosure is directed to aqueous dispersions with polymer particles. In one aspect, a method of treating a plant is disclosed. The method may include applying a suspension to a surface of the plant. Exemplary suspensions may comprise an aqueous medium and a plurality of particles. Each particle in the plurality of particles may include polymeric carrier material and an active ingredient dispersed throughout the particle.

In another aspect, a method of making a suspension is disclosed. The example method may include adding polymer material to an organic solvent such that the polymer material is present in the organic solvent at a concentration that is less than 20 wt %, adding an active ingredient to the organic solvent, agitating the organic solvent with the polymer material and the active ingredient, thereby generating an organic solvent mixture, adding aqueous media to the organic solvent mixture, thereby generating particles, and removing the organic solvent, thereby generating an aqueous suspension comprising no more than 5% by volume organic solvent. The active ingredient may be one of the following: an insecticide, a fungicide, and a pesticide. The particles may include polymer material dispersed throughout each particle and active ingredient dispersed throughout each particle.

There is no specific requirement that a material, technique or method relating to aqueous dispersions including polymer particles include all of the details characterized herein, in order to obtain some benefit according to the present disclosure. Thus, the specific examples characterized herein are meant to be exemplary applications of the techniques described, and alternatives are possible.

### BRIEF DESCRIPTION OF THE DRAWINGS

FIG. 1 shows an example method of making a suspension.

FIG. 2A is a photograph of an example suspension made using 0.5% cellulose diacetate (CDA). FIG. 2B is a photograph of an example suspension made using 1% cellulose diacetate (CDA). FIG. 2C is a photograph of an example suspension made using 2% cellulose diacetate (CDA). FIG. 2D is a photograph of an example suspension made using 4% cellulose diacetate (CDA).

FIG. 3A is a micrograph of cellulose diacetate particles obtained from the suspension shown in FIG. 2A. FIG. 3B is a micrograph of particles obtained from 4 wt % suspension of cellulose diacetate.

FIG. 4A shows micrographs of cellulose acetate particles obtained from 2 wt % suspension. FIG. 4B shows micrographs of cellulose acetate particles obtained from 4 wt % suspension.

FIG. 5A shows micrographs of cellulose acetate propionate particles obtained from 2 wt % suspension. FIG. 5B shows micrographs of cellulose acetate propionate particles obtained from 4 wt % suspension.

FIG. 6A shows micrographs of cellulose acetate butyrate particles obtained from 2 wt % suspension. FIG. 6B shows micrographs of cellulose acetate butyrate particles obtained from 4 wt % suspension.

FIG. 7 is an annotated photograph showing areas of a silicon wafer imaged during adhesion testing of cellulose diacetate.

FIG. 8 is a micrograph of one area of the coated substrate of FIG. 7.

FIG. 9 is a micrograph of one area of a dip-coated silicon wafer in 0.5% CDA suspension

FIG. 10 is a schematic illustration of a sample after centrifuge spinning prepared for fungicide loading and release testing on cellulose diacetate.

FIG. 11 is a chart showing experimental results for fungicide loading and release testing for CDA, CAP, CAB samples and a control.

FIG. 12 shows Day 0 of an example petri dish during experimental formulation performance testing.

FIGS. 13A-13D and FIGS. 14A-14C are photographs of petri dishes taken on Day 4 of experimental testing for different formulations. More specifically, FIG. 13A, FIG. 13B, FIG. 13C and FIG. 13D show the petri dishes on day 4 for the untreated control (UC), CDA+fluopyram (FP) (1 ppm), CDA+FP and 0.1% Triton (T) (1 ppm), and FP+T (1 ppm), respectively. FIG. 14A, FIG. 14B, and FIG. 14C show the petri dishes on day 4 for CDA+FP (5 ppm), CDA+FP+T (5 ppm), and FP+T (5 ppm), respectively.

FIGS. 13E-13H and FIG. 14D-14F are photographs of petri dishes taken on Day 7 of experimental testing for different formulations. More specifically, FIG. 13E, FIG. 13F, FIG. 13G and FIG. 13H show the petri dishes on day 7 for the untreated control (UC), CDA+FP (1 ppm), CDA+FP+T (1 ppm), and FP+T (1 ppm), respectively. FIG. 14D, FIG. 14E, and FIG. 14F show the petri dishes on day 7 for CDA+FP (5 ppm), CDA+FP+T (5 ppm), and FP+T (5 ppm), respectively.

FIGS. 13I-13L and FIG. 14G-14I are photographs of petri dishes taken on Day 10 of experimental testing for different formulations. More specifically FIG. 13I, FIG. 13J, FIG. 13K and FIG. 13L show the petri dishes on day 10 for the untreated control (UC), CDA+FP (1 ppm), CDA+FP+T (1 ppm), and FP+T (1 ppm), respectively. FIG. 14G, FIG. 14H, and FIG. 14I show the petri dishes on day 10 for CDA+FP (5 ppm), CDA+FP+T (5 ppm), and FP+T (5 ppm), respectively.

FIG. 15 is a chart showing percent inhibition of the CDA+FP (4), CDA+FP+T (5), and FP+T (6) formulations at different concentrations of fluopyram: Low (1 ppm fluopyram), Medium (5 ppm fluopyram), High (10 ppm fluopyram), and Highest (20 ppm fluopyram).

FIG. 16 shows a plot of the radial growth for CDA+FP (the CDA particles with fluopyram) at a fluopyram concentration of 1 ppm (“4L”) compared to the untreated control (“UC”).

FIG. 17 is a chart showing apparent contact angle of cellulose acetate, cellulose diacetate, cellulose acetate propionate and cellulose acetate butyrate suspensions and water on tomato, banana, redbud, bay laurel, citrus and grass leaves.

FIG. 18 is a chart showing apparent contact angle of triton containing cellulose acetate, cellulose diacetate, cellulose acetate propionate and cellulose acetate butyrate suspensions on tomato, banana, redbud, bay laurel, citrus and grass leaves.

FIG. 19 is a chart showing zeta potential values of cellulose acetate, cellulose diacetate, cellulose acetate propionate and cellulose acetate butyrate suspensions with and without the surfactant.

### DETAILED DESCRIPTION

Systems and methods disclosed and contemplated herein relate to aqueous suspensions with polymer particles including active ingredient. Generally, the aqueous suspensions include an aqueous medium and particles, where each particle includes polymeric carrier material and active ingredient. Typically, both the polymeric carrier material and the active ingredient are dispersed throughout the particle.

In some instances, exemplary aqueous suspensions can be used for crop protection. In those applications, exemplary aqueous suspensions can be sprayed on crop leaves. Example diseases, pests, and insects currently affect various agricultural products, such as bananas, apple, peach and pear trees, rice, peanuts, maize, wheat, tobacco, tomatoes, to name a few.

Current crop protection methods have various issues. As an example, a current method to control Black Sigatoka (Pseudocercospora fijiensis) is an application of fungicides as a protectant (prophylactic) or systemic (therapeutic) to banana plant leaves. However, both types of fungicides are applied to the leaves as formulations in oil or oil-in-water emulsions. The non-porous oil coatings on the leaves reduce transpiration, photosynthesis, and can affect crop yield. Additionally, the moist climate in banana growing regions can lead to frequent run-off of the fungicide formulation from the plate leaves. Accordingly, plants can require multiple applications of fungicides, such as 50 sprays per year. Frequent fungicide application can add to farmers' expenses and increase environmental pollution, but also can result in development of resistant fungi.

Exemplary aqueous polymer suspensions generated using the systems and methods disclosed herein can have one or more of the following properties. As one example, aqueous polymer suspensions can occupy small areas of the leaves, thereby allowing gas diffusion and not interfering with plant transpiration and photosynthesis activity. As another example, aqueous polymer suspensions can release active ingredient in the particles over a period of time, which can reduce the number of applications and may prevent the targets from developing resistance. As another example, aqueous polymer suspensions can adhere to crop leaves and can withstand heavy rain, which can reduce the number of applications. As another example, polymeric carrier can be biodegradable polymer that can be naturally decomposed in the post-use term, wherein the biodegradability is greater than 90% in 1 month, 3 months, 6 months, 12 months, 18 months or 24 months. That said, there is no requirement that a coating resulting from instantly disclosed systems and methods include all of the aforementioned properties, in order to obtain some benefit according to the present disclosure.

### A. Definitions

Unless otherwise defined, all technical and scientific terms used herein have the same meaning as commonly understood by one of ordinary skill in the art. In case of conflict, the present document, including definitions, will control. Example methods and materials are described below, although methods and materials similar or equivalent to those described herein can be used in practice or testing of the present disclosure. The materials, methods, and examples disclosed herein are illustrative only and not intended to be limiting.

The terms “comprise(s),” “include(s),” “having.” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising.” “consisting of” and “consisting essentially of,” the embodiments or elements presented herein, whether explicitly set forth or not.

Definitions of specific functional groups and chemical terms are described in more detail below. For purposes of this disclosure, the chemical elements are identified in accordance with the Periodic Table of the Elements, CAS version, Handbook of Chemistry and Physics, 75th Ed., inside cover, and specific functional groups are generally defined as described therein.

For the recitation of numeric ranges herein, each intervening number there between with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

### II. Example Suspensions

Example suspensions disclosed and contemplated herein typically include an aqueous medium and a plurality of particles. In various implementations, example suspensions can include additional components. The sections below discuss various aspects of exemplary suspensions.

### A. Example Aqueous Media

Components of exemplary suspensions are dispersed in an aqueous medium. That is, the primary medium of the suspensions is water. In some instances, one or more additional components are present in the aqueous medium. For instance, aqueous media can include organic solvent.

When present, organic solvent is typically less than 10% by volume of the aqueous medium. In some implementations, organic solvent is less than 5% by volume; less than 1% by volume; or less than 0.5% by volume of the aqueous medium. The aqueous medium may comprise at least 0.1% by volume, at least 0.2% by volume, at least 0.3% by volume, at least 0.4% by volume of organic solvent. In some embodiments, the aqueous medium may comprise about 0.1% to about 10% by volume organic solvent.

One or more various organic solvents may be present in the aqueous medium, such as acetone, dioxane, chloroform, methylene chloride, acetic acid, tetrahydrofuran, dimethylformamide, and/or N,N-dimethylacetamide.

### B. Exemplary Particles

Exemplary particles dispersed in aqueous suspensions disclosed herein include polymeric carrier material and an active ingredient. Polymeric carrier material and active ingredient are usually dispersed throughout exemplary aqueous suspensions.

Polymeric carrier material suitable for applications disclosed herein can have one or more of the following properties: low water wettability, biodegradability, favorable adhesion and surface wettability, and processability in common solvents.

In some instances, polymeric carrier material may include a cellulose ester. The cellulose ester can be a cellulose ester comprising a plurality of alkanoyl substituents chosen from acetyl, propionyl, butyryl or combinations thereof. Exemplary cellulose esters may have a total degree of substitution for the alkanoyl substituents that is from 1 to 3.0; from 2.0-2.95; from 2.0 to 2.85; from 1.8 to 2.85; from 2.4-2.6; from 2.6-3.0; from 2.2-2.7; from 2.4-2.85; or from 2.3-2.8.

For example, polymeric carrier material can include cellulose acetate, cellulose diacetate, cellulose acetate propionate or cellulose acetate butyrate. In some embodiments, polymeric carrier material can be a cellulose ester having an average molecular weight, Mₙ, of 30,000-50,000, and a degree of substitution of 2.45-2.85.

In some instances, the polymeric carrier material may include a polylactic acid (PLA). In some instances, the polymeric carrier material may include a polyhydroxyalkanoate (PHA), such as poly-3-hydroxybutyrate (PHB), polyhydroxyvalerate (PHV), and polyhydroxyhexanoate (PHH). The polymeric material may include combinations of these materials.

The active ingredient can include one or more of an insecticide, a fungicide, and a pesticide. The active ingredient may be approved for use by the U.S. Environmental Protection Agency (EPA). In some instances, active ingredient can be fluopyram. Fluopyram can be used against fungal diseases such as gray mold (Botrytis), powdery mildew, apple scab, Alternaria Sclerotinia, and Monilinia. In other implementations, various fungicides like chlorothalonil, SDHI class, azoxystrobin, copper fungicides and sulfur fungicides can be used as active ingredients. In some instances, organophosphates, nicotinoids, carbamates and avermectin can be used as insecticides.

Exemplary particles can include varying amounts of polymeric carrier material. For instance, exemplary particles can include, by weight, less than 20%; less than 18%; less than 15%; less than 12%; or less than 10%; less than 8 wt %; less than 5 wt %; less than 3 wt % less than 2 wt % or less than 1 wt % of polymeric carrier material. In various implementations, exemplary particles include polymeric carrier material in an amount that is no less than 0.1 wt %; no less than 1 wt %; no less than 3 wt %; no less than 5 wt %; no less than 8 wt %; no less than 10 wt %; no less than 12 wt %; no less than 15 wt %; or no less than 19 wt %. In various implementations, exemplary particles may include polymeric carrier material at from 0.1 wt % to 19.9 wt %; 0.1 wt % to 10 wt %; 10 wt % to 19.9 wt %; 10 wt % to 15 wt %; 15 wt % to 19.9 wt %; 0.1 wt % to 8 wt %; from 1 wt % to 5 wt %; from 2 wt % to 4 wt %; from 0.1 wt % to 5 wt %; from 0.5 wt % to 3 wt %; from 5 wt % to 10 wt %; or from 2 wt % to 6 wt %.

Exemplary particles can have varying sizes and distributions of sizes. For instance, exemplary particles can have an average diameter of from 25 nm to 5 μm. In various implementations, exemplary particles have an average diameter of from 25 nm to 5 μm; from 50 nm to 4 μm; from 100 nm to 3 μm; from 1 μm to 5 μm; from 1 μm to 4 μm; from 50 nm to 350 nm; from 100 nm to 250 nm; from 50 nm to 100 nm; from 75 nm to 300 nm; from 200 nm to 400 nm; from 200 nm to 300 nm; or from 300 nm to 400 nm, from 400 nm to 500 nm, from 400 nm to 600 nm, from 500 nm to 700 nm, from 600 nm to 800 nm, from 700 nm to 900 nm, from 700 nm to 1000 nm, from 800 nm to 1100 nm. The particle size may be less than 4 μm; less than 2 μm; less than 1 μm; less than 900 nm; less than 700 nm; less than 500 nm; less than 300 nm; less than 200 nm; or less than 100 nm. The particle size may be greater than 50 nm, greater than 100 nm, greater than 200 nm, greater than 250 nm, greater than 300 nm; greater than 400 nm; greater than 500 nm; greater than 750 nm; greater than 900 nm; greater than 1 μm; greater than 3 μm; or greater than 4 μm.

Exemplary particles can release active ingredient over time. Without being bound by a particular theory, active ingredient incorporated in the polymer carrier material matrix may release as the polymer carrier material degrades.

In some instances, active ingredient can be continuously released from exemplary particles for an initial period of time. For example, an active ingredient release rate is 40-63% for the first 3 hours; 40-65% for first 9 hours; or 40-68% for first 24 hours after application of the suspension.

In some instances, active ingredient can be released over a period of time greater than 24 hours. As one example, active ingredient may be released at a continuous rate for 24 hours, after which 60%-90% of the active ingredient, by weight, has been released. Then the remaining amount of active ingredient can be released over the following 12 hours; 24 hours; 36 hours; 48 hours; 72 hours; 120 hours or 144 hours, at one or more release rates that may be different from the initial release rate.

Exemplary particles may optionally comprise one or more surfactants. Example surfactants may be polymeric or non-polymeric. Exemplary surfactants may be bio surfactants, synthetic surfactants, non-ionic surfactants, anionic surfactants, or cationic surfactants. Addition of surfactant may enable selectively adjusting exemplary particles for different target surfaces (e.g., plant substrates) by reducing the surface tension of the carrier from 70 to 25 dynes/cm.

When present, exemplary particles may comprise 0.005 wt % to 2 wt % surfactants. For instance, exemplary particles may comprise 0.005 wt % to 1 wt %; 1 wt % to 2 wt %; 0.005 wt % to 0.1 wt %; 0.1 wt % to 1.0 wt %; or 0.05 wt % to 1.5 wt % surfactant.

Exemplary particles can spread on various surfaces equal to or faster than water. Spreading may be measured via interfacial tension of an exemplary suspension and the apparent contact angle with the help of a goniometer provided with a digital camera. The protocol followed was published and is approved as D7334-08 by ASTM in 2013. In some cases, a First Ten Angstroms, Inc. FTA1000B goniometer (Portsmouth, VA) can be used to measure interfacial tension and apparent contact angle of suspensions and water on model surfaces, such as silicon wafers and on banana, tomato, bay laurel, citrus and grass leaves. The interfacial tension of water may drop from 23-31% while the contact angle of suspensions drops between 20-40% within 3-5 minutes of the drop landing on the surface.

Exemplary particles can adhere to various surfaces for varying periods of time. For instance, after applying an exemplary suspension to a tomato leaf, and subjecting the tomato leaf to 5 minutes of continuous water flow at the rate of 8-9 liters/minute, at least 40%; at least 50%; at least 60%; at least 70%; or at least 80% of the initial particles still adhere to the tomato leaf. In various implementations, after applying an exemplary suspension to a leafy substrate, and subjecting the leafy substrate to 5 minutes of continuous water flow, 40% to 85%; 40% to 60%; 60% to 80%; 50% to 70%; or 40% to 70% of the initial particles still adhere to the leafy substrate.

Exemplary particles can load about 150 to about 250 micrograms of active ingredient per fluid ounce of suspension. In various implementations, exemplary particles can load active ingredient at 150 to 250 μg/fl oz suspension; 150 to 200 μg/fl oz suspension; 200 to 250 μg/fl oz suspension; 150 to 180 μg/fl oz suspension; 180 to 210 μg/fl oz suspension; 210 to 250 μg/fl oz suspension; 150 to 160 μg/fl oz suspension; 160 to 170 μg/fl oz suspension; 170 to 180 μg/fl oz suspension; 180 to 190 μg/fl oz suspension; 190 to 200 μg/fl oz suspension; 200 to 210 μg/fl oz suspension; 210 to 220 μg/fl oz suspension; 220 to 230 μg/fl oz suspension; 230 to 240 μg/fl oz suspension; or 240 to 250 μg/fl oz suspension. Exemplary particles can load about 15 wt % to about 25 wt % of the active ingredient. In various implementations, exemplary particles can load 15 wt % to 25 wt %; 15 wt % to 20 wt %; 20 wt % to 25 wt %; 15 wt % to 18 wt %; 18 wt % to 21 wt %; 21 wt % to 25 wt %; 15 wt % to 16 wt %; 16 wt % to 17 wt %; 17 wt % to 18 wt %; 18 wt % to 19 wt %; 19 wt % to 20 wt %; 20 wt % to 21 wt %; 21 wt % to 22 wt %; 22 wt % to 23 wt %; 23 wt % to 24 wt %; or 24 wt % to 25 wt % of the active ingredient.

### III. Example Methods for Making Suspensions

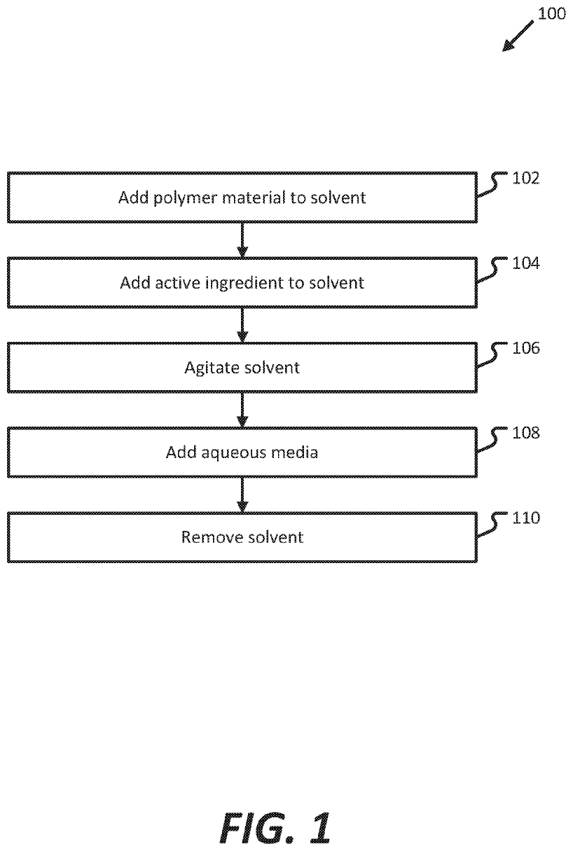

FIG. 1 shows example method 100 for making a suspension. Method 100 includes adding polymer material to a solvent (operation 102), adding active ingredient to a solvent (operation 104), agitating the solvent (operation 106), adding aqueous media (operation 108), and removing solvent (operation 110). Other embodiments can include more or fewer operations.

Example method 100 begins by adding polymer material to a solvent (operation 102). Polymer material can be added to the solvent (operation 102) until a predetermined weight percent of the polymer material in the solvent is achieved. For instance, polymer material can be added to the solvent (operation 102) such that polymer material is present in the organic solvent at a concentration that is less than about 20 wt %, such as no more than 0.1 wt %; no more than 0.25 wt %; no more than 0.5 wt %; no more than 1 wt %; no more than 2 wt %; no more than 4 wt %; no more than 5 wt %; no more than 8 wt %; no more than 10 wt %; no more than 12 wt %; no more than 15 wt %; no more than 17 wt % or no more than 19 wt %. They polymer material may be present in the organic solvent in an amount of at least 0.1 wt %; at least 0.5 wt %; at least 1 wt %; at least 2 wt %; at least 5 wt %; at least 8 wt %; at least 10 wt %; at least 12.5 wt %; at least 15 wt %; at least 17.5 wt % or at least 19 wt %. In various implementations, polymer material can be added to the solvent (operation 102) such that polymer material is present in the organic solvent at from 0.1 wt % to 19.9 wt %; 0.1 wt % to 10 wt %; 10 wt % to 19.9 wt %; 10 wt % to 15 wt %; 15 wt % to 19.9 wt %; 0.1 wt % to 5 wt %; from 0.25 wt % to 4 wt %; from 1 wt % to 3 wt %; or from 0.5 wt % to 3 wt %.

Active ingredient may be added to the solvent (operation 104). In some instances, active ingredient is added to the solvent at the same time as the polymer material. Active ingredient can be added to the solvent or the solvent and polymer material mixture such that active ingredient is present at from about 0.001 wt % to about 0.015 wt %. In various implementations, active ingredient can be present in the organic solvent or the solvent and polymer material mixture at at least 0.001 wt %; at least 0.005 wt %; at least 0.01 wt %; or at least 0.015 wt %. The active ingredient can be present in the organic solvent or the solvent and polymer material mixture at less than 0.015 wt %.

After adding the polymer material (operation 102) and adding the active ingredient (operation 104) to the solvent, the solvent mixture is agitated (operation 106). In some instances, agitating the mixture (operation 106) dissolves some or all of the polymer material and some or all of the active ingredient in the solvent.

Next, aqueous media is added to the solvent mixture (operation 108). In some instances, aqueous media is water. Aqueous media can be added in doses. For example, aqueous media doses can be about 1%; about 2%; about 5%; or about 10% of the total volume of the solvent mixture. In some instances, the aqueous media is added to the organic solvent mixture in doses that are no more than 2% of the solvent mixture volume.

As aqueous media is added to the solvent (operation 108), particles are generated in the solvent. The generated particles include polymer material dispersed throughout each particle and active ingredient dispersed throughout each particle. Various aspects of particles generated during method 100 are discussed in greater detail above.

The solvent may be removed (operation 110), thereby generating an aqueous suspension. In some instances, the resulting aqueous suspension includes no more than 5% by volume solvent. In some instances, the aqueous suspension includes no more than 2%; no more than 1%; or no more than 0.5% by volume solvent.

Solvent can be removed (operation 110) using various methods known in the art. For instance, solvent can be removed by evaporation, such as open-air evaporation or reduced pressure evaporation.

### IV. Example Methods of Using Exemplary Suspensions

Exemplary suspensions disclosed and contemplated herein can be implemented in various ways. For example, exemplary suspensions can be used for applications where encapsulating active ingredient and releasing active ingredient over a period of time is desired. Particular applications of exemplary suspensions include application to plants, where the active ingredient is one or more of insecticide, fungicide, and pesticide.

An example method may include treating a plant or plant surface. The example method may include providing an exemplary suspension as described in greater detail herein. For instance, the exemplary suspension may include an aqueous medium and a plurality of particles dispersed throughout the aqueous medium. Each particle in the plurality of particles may include polymeric carrier material and active ingredient dispersed throughout the particle.

The example method may comprise applying the suspension to a surface of the plant. For instance, an exemplary suspension may be sprayed onto crops in a field using application techniques known in the art. Exemplary plant surfaces may include leafy substrates, such as leaves, stems, and/or seeds. Exemplary plants may include tomato, banana, soybean, small grains, peanut, spinach, cabbage, lettuce, olives, rubber, sorghum, potato, cotton, sweet potato, corn, and citrus plants.

### V. Experimental Examples

Various experiments were conducted, and the results are discussed below.

### A. Exemplary Particle Synthesis

Exemplary particles were synthesized using varying amounts of polymeric carrier material to investigate how concentration of polymeric carrier material affects particle size and suspension stability. Four samples were prepared at ambient conditions. In a first preparation step, four different concentrations of 5 mL cellulose diacetate solution were prepared in acetone: 0.5% CDA, 1% CDA, 2% CDA, and 4% CDA. The CDA was obtained from Eastman Chemical Co. and the acetone was obtained from Fisher Scientific.

In other preparation setups, two different concentrations each of 5 mL cellulose acetate (CA), cellulose acetate propionate (CAP), and cellulose acetate butyrate (CAB) solution were prepared in acetone: 2% CA, 2% CAP, 2% CAB, 4% CA, 4% CAP and 4% CAB. The CA, CAP and CAB was obtained from Eastman Chemical Co. and the acetone was obtained from Fisher Scientific.

In another preparation step, two different concentrations each of 5 mL cellulose acetate, cellulose acetate propionate and cellulose acetate butyrate solution were prepared in acetone: 2% CA-T, 2% CAP-T, 2% CAB-T, 4% CA-T, 4% CAP-T and 4% CAB-T with 0.1% of triton (T) as surfactant. Triton was obtained from Sigma-Aldrich.

Then a fungicide, fluopyram, was added to each sample's mixture. Fluopyram was obtained from Bayer and Fisher Scientific

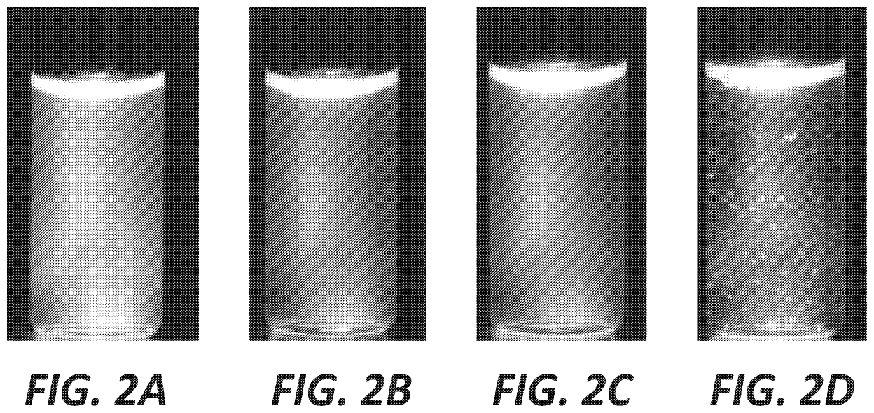

Particles were obtained by dropwise addition of 10 mL DI water. Photographs were taken of each of the samples after dropwise addition of the DI water and after dilution to 0.01% for imaging purposes. FIG. 2A shows the suspension made using 0.5% CDA; FIG. 2B shows the suspension made using 1% CDA; FIG. 2C shows the suspension made using 2% CDA; and FIG. 2D shows the suspension made using 4% CDA.

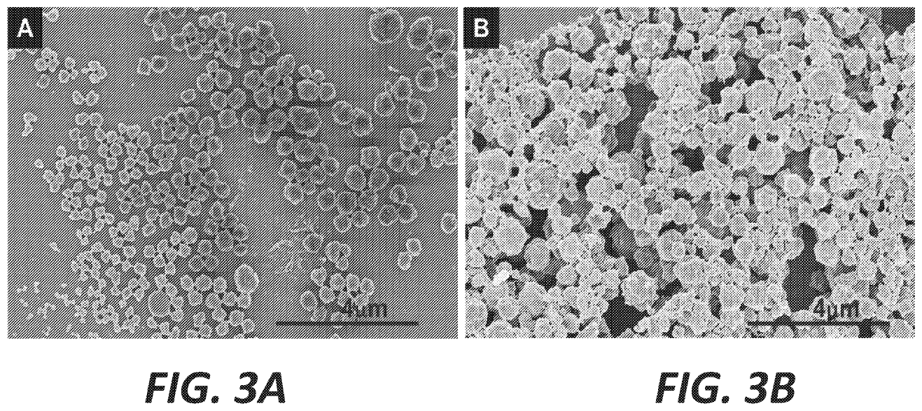

Next, acetone was removed from each sample by heating the acetone-DI mixture at 80° C. until the acetone concentration was less than 0.5% by volume in each sample. FIG. 3 is a photomicrograph of particles obtained from the suspension shown in FIG. 2A.

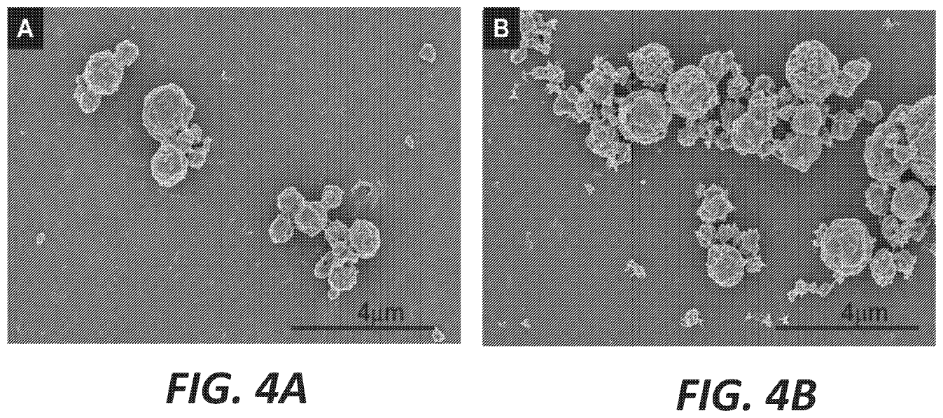

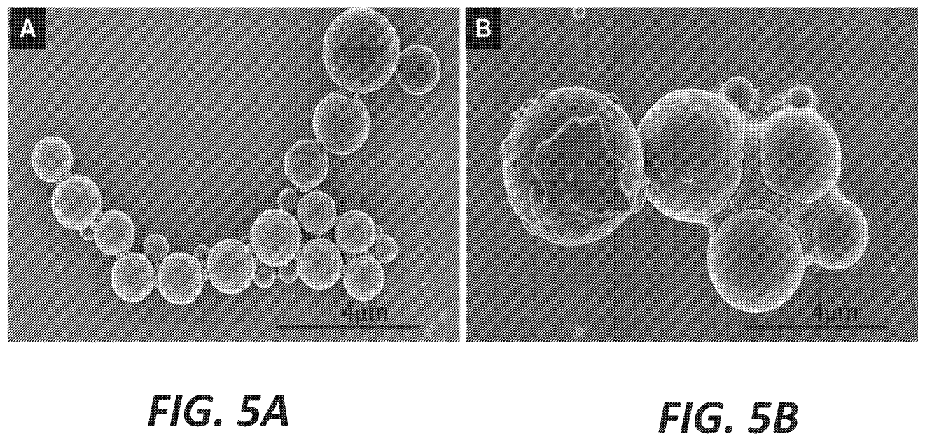

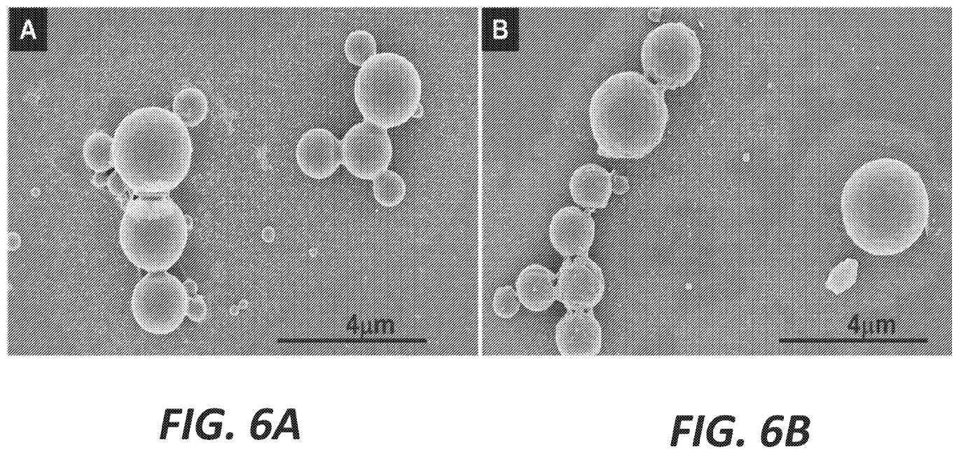

The photomicrographs shown in FIGS. 3, 4, 5, and 6 were obtained using a field emission scanning electron microscope (FESEM), the Verios FE1 from Thermo Fisher Scientific. It was observed that the average particle width was between 250-950 nm.

Based on these samples, it was observed that less than 2 wt % of CDA in acetone generates particles with roughly uniform size without aggregation of the particles.

### B. Particle Adhesion Experiments

Experiments were conducted to quantify adhesion of exemplary particles on a substrate. Particles generated from 0.5 wt % of CDA in acetone were drop coated on the surface of a substrate. Three different substrates were tested: surface of a silicon wafer, polydimethylsiloxane (PDMS) film, and a tomato leaf. Apparent contact angles for each substrates were determined using a First Ten Angstroms goniometer, and found to be: just less than 50° for the silicon wafer, just less than 120° for the PDMS film, and about 80° for the tomato leaf.

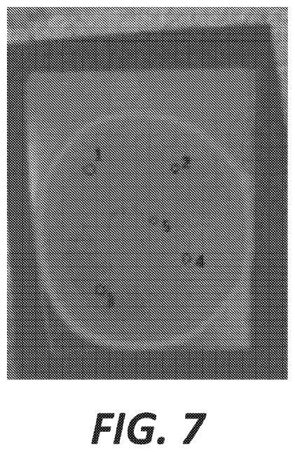

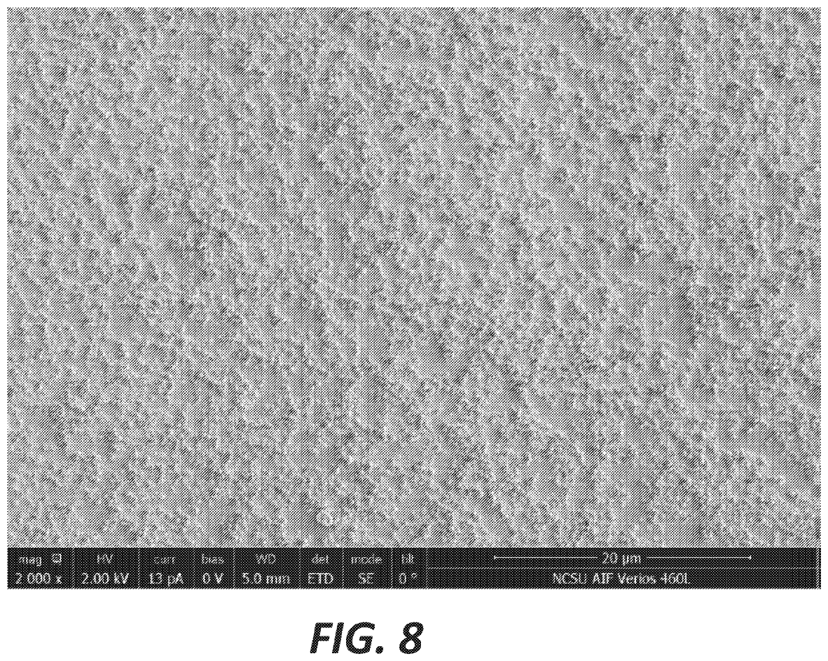

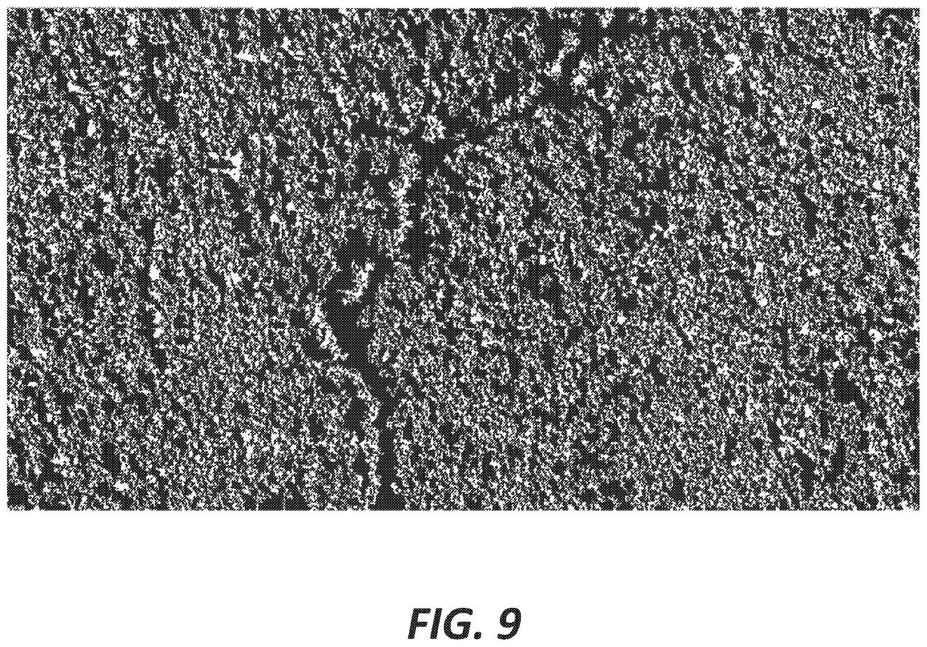

Five areas of the substrate were then imaged using a field emission scanning electron microscope (FESEM), the Verios FE1 from Thermo Fisher Scientific. FIG. 7 shows 5 areas imaged on the surface of a silicon wafer. FIG. 8 is an image of one area of 0.5% CDA coated substrate (silicon wafer) using the FESEM. FIG. 9 is an image of one area of a dip-coated silicon wafer in 0.5% CDA suspension.

Then, the surface was rinsed with water and the same five areas were again imaged using the FESEM. After 5 minutes of rinsing with water, the percentage area coverage of the silicon wafer was 80±14%; of the PDMS film was 75±12%; and of the tomato leaf was 41±10%.

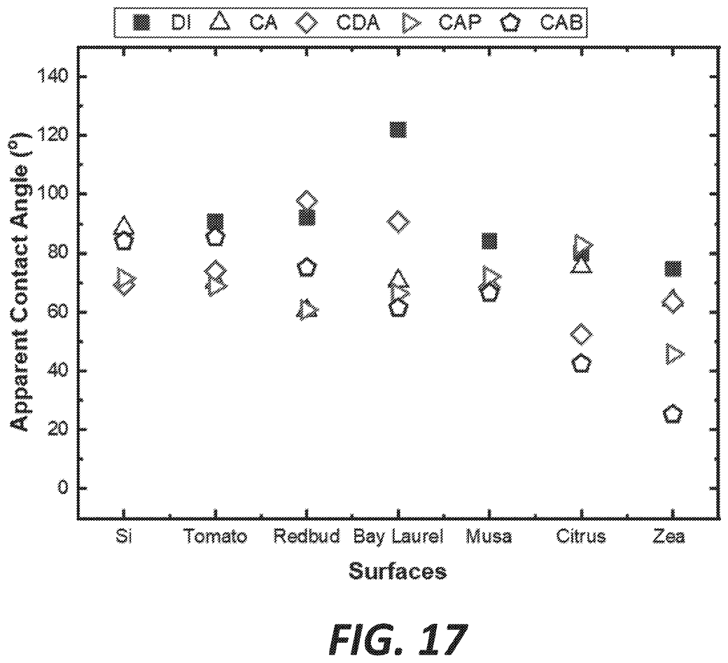

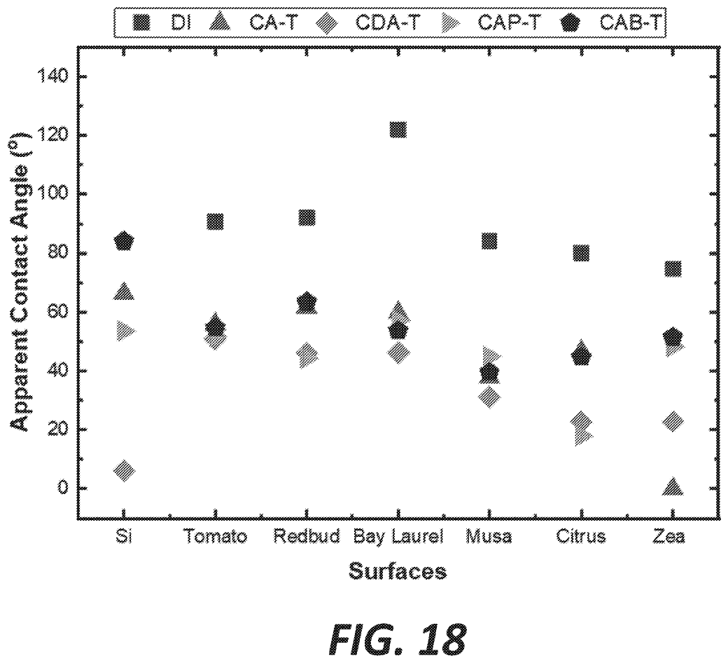

Apparent contact angles of droplets of 2% CA, CDA, CAP and CAB with and without surfactant were determined on silicon wafers and banana, tomato, bay laurel, citrus and grass leaves using a First Ten Angstroms goniometer, and found to be equal to or less than that of water on all the surfaces. Suspensions containing surfactant showed further decreases in the contact angle and faster spreading on all the surfaces. Plots showing apparent contact angle of suspensions with and without surfactant on various surfaces are shown in FIG. 17 and FIG. 18.

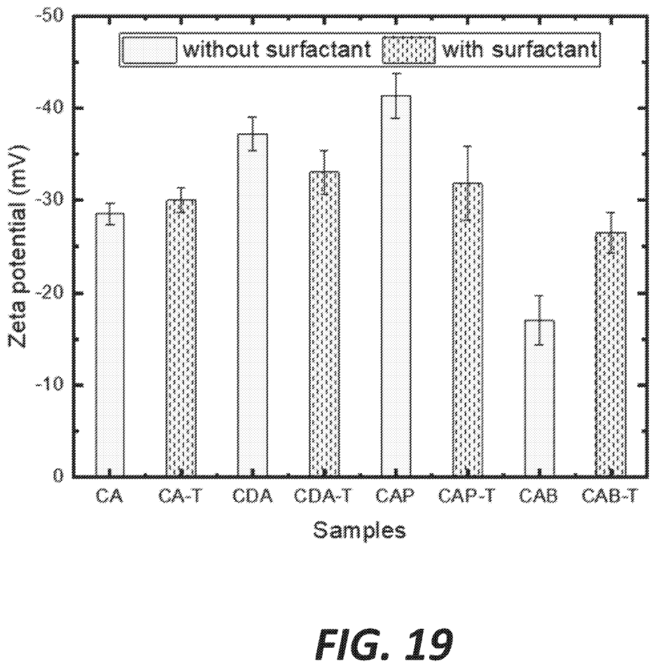

Suspension stability was measured via dynamic light scattering. Most of the suspensions show zeta potential values of −30 mV or above that indicates stable dispersions. Results of the DLS studies are shown in FIG. 19.

Probability of spreading of the particles was estimated through interfacial tension measurements. All the suspensions showed lesser interfacial tension than water with ˜55% reduction when surfactant is added in the suspension.

### C. Fungicide Loading and Release

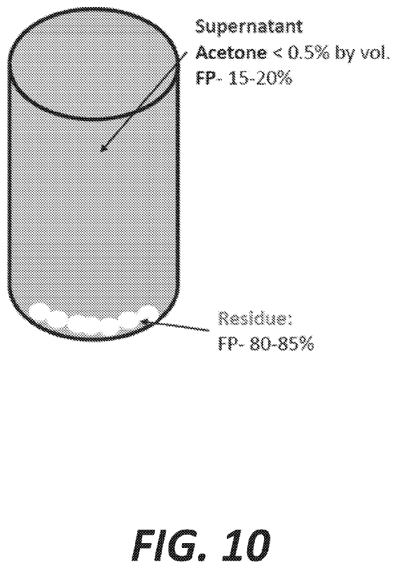

Experiments were conducted to evaluate the load and release profile of fluopyram on particles at room temperature and pressure. The 0.5% CDA sample from Section A above was subjected to a centrifuge. FIG. 10 is a schematic illustration of the sample after centrifuge spinning. As indicated in FIG. 10, the supernatant included less than 0.5% acetone by volume and 15-20% fluopyram, and the residue included fluopyram at 80-85%. Measurement of the fluopyram and acetone was done via HPLC using a Phenomenex Kinetex C₁₈ separation column.

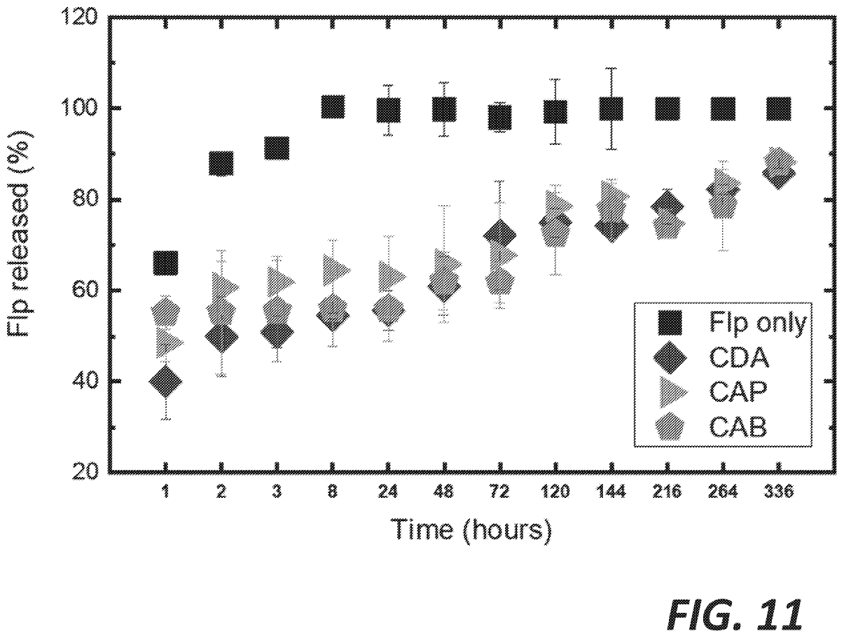

Next, the residue of fluopyram in the CDA, CAP and CAB particles was separated and suspended in DI water. Two batches were generated: a sample with fluopyram-loaded CDA particles and a control with only fluopyram (solubility in water of 16 μg/mL). Then a known amount of the sample or the control was deposited on a silicon wafer and aliquots were taken at specific intervals. Results of the sample and control are shown in FIG. 11.

As shown in FIG. 11, the initial release rate of the sample and the control are roughly the same. Also, even after 7 days of release, not all of the fungicide is released in the sample. In fact, fungicide retention might be advantageous. That is, fluopyram incorporated in the matrix may release when the cellulose esters (CDA, CAB, CAP) degrade. Broadly, FIG. 11 demonstrates that the fungicide initial rate of release does not change when it is loaded onto the particles as compared to the fungicide alone. FIG. 11 also demonstrates that part of the fungicide is retained on the particles.

### D. Formulation Performance

Exemplary particles were compared to a commercial formulation. Six formulations were used: (1) an untreated control (UC), (2) acetone+0.1% Triton, (3) CDA particles only, (4) CDA particles with fluopyram (CDA+FP), (5) CDA particles with fluopyram and 0.1% Triton (CDA+FP+T), and (6) Acetone with fluopyram and 0.1% Triton (FP+T). Four concentrations of fluopyram were tested: Low (L) of 1 ppm, Medium (M) of 5 ppm, High (H) of 10 ppm, and Highest (HT) of 20 ppm.

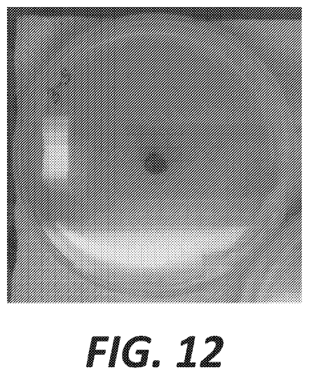

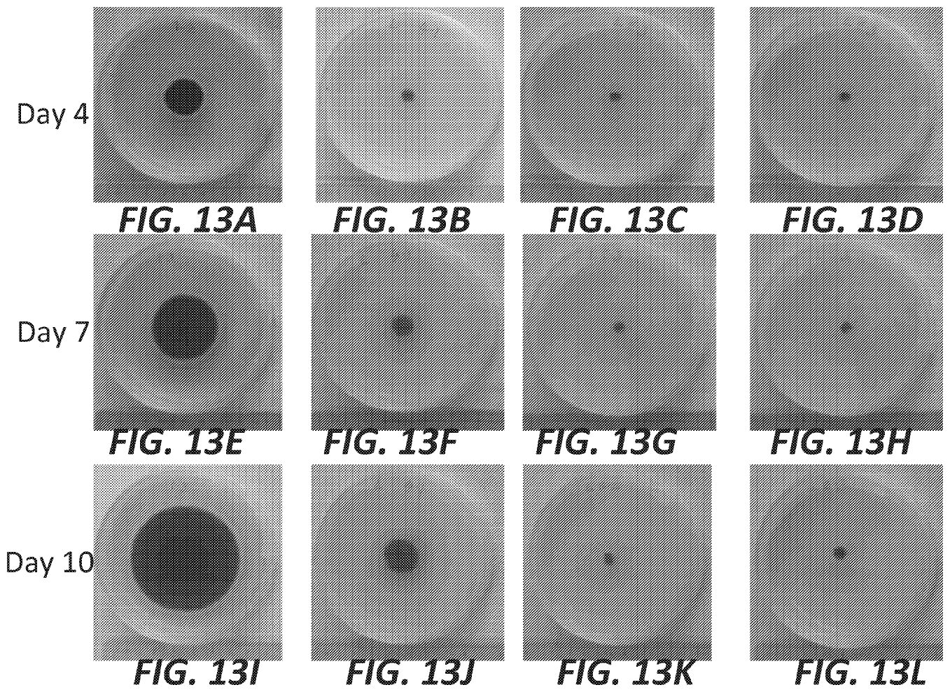

A 4.8 mm diameter mycelial plug from an 11-day old plate of Alternaria linariae (A. tomatophila) was placed in the center of petri dishes containing full strength acidic potato dextrose agar (APDA). The concentration of fluopyram in the treatments were as above 1 ppm, 5 ppm, 10 ppm, and 20 ppm. The petri dishes were stored at 24° C. under 16 hours light and 8 hours dark conditions. FIG. 12 shows Day 0 of an example petri dish.

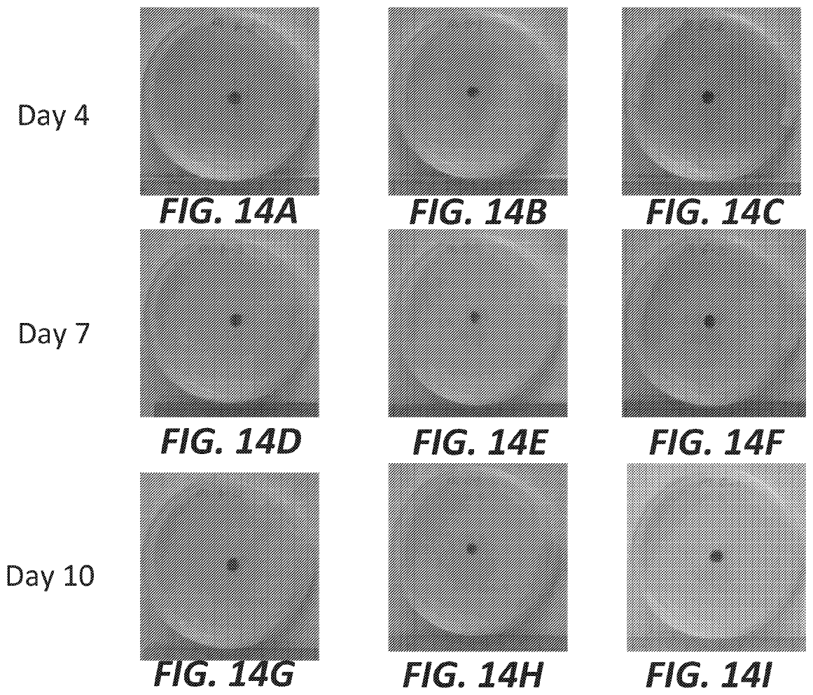

On the fourth day, the petri dishes were imaged. FIG. 10A, FIG. 10B, FIG. 10C and FIG. 10D show the petri dishes on day 4 for the untreated control (UC), CDA+FP (1 ppm), CDA+FP+T (1 ppm), and FP+T (1 ppm), respectively. FIG. 14A, FIG. 14B, and FIG. 14C show the petri dishes on day 4 for CDA+FP (5 ppm), CDA+FP+T (5 ppm), and FP+T (5 ppm), respectively.

On the seventh day, the petri dishes were imaged. FIG. 10E, FIG. 10F, FIG. 10G and FIG. 10H show the petri dishes on day 7 for the untreated control (UC), CDA+FP (1 ppm), CDA+FP+T (1 ppm), and FP+T (1 ppm), respectively. FIG. 14D, FIG. 14E, and FIG. 14F show the petri dishes on day 7 for CDA+FP (5 ppm), CDA+FP+T (5 ppm), and FP+T (5 ppm), respectively.

On the tenth day, the petri dishes were imaged. FIG. 10I, FIG. 10J, FIG. 10K and FIG. 10L show the petri dishes on day 10 for the untreated control (UC), CDA+FP (1 ppm), CDA+FP+T (1 ppm), and FP+T (1 ppm), respectively. FIG. 14G, FIG. 14H, and FIG. 14I show the petri dishes on day 10 for CDA+FP (5 ppm), CDA+FP+T (5 ppm), and FP+T (5 ppm), respectively.

As shown in the figures, there are roughly equal growth in the petri dishes for CDA+FP, CDA+FP+T, and for FP+T, which indicates that the fluopyram loaded particles are as effective as the commercial formulations for a fungicide concentration of 5 ppm.

The percent inhibition at Day 10 was determined for CDA+FP, CDA+FP+T, and for FP+T at the four different fluopyram concentrations. The percent inhibition was calculated using the following formula:

$$\% inhibition = 1 - \frac{radial growth in sample}{radial growth in untreated control} \times 100 \%$$

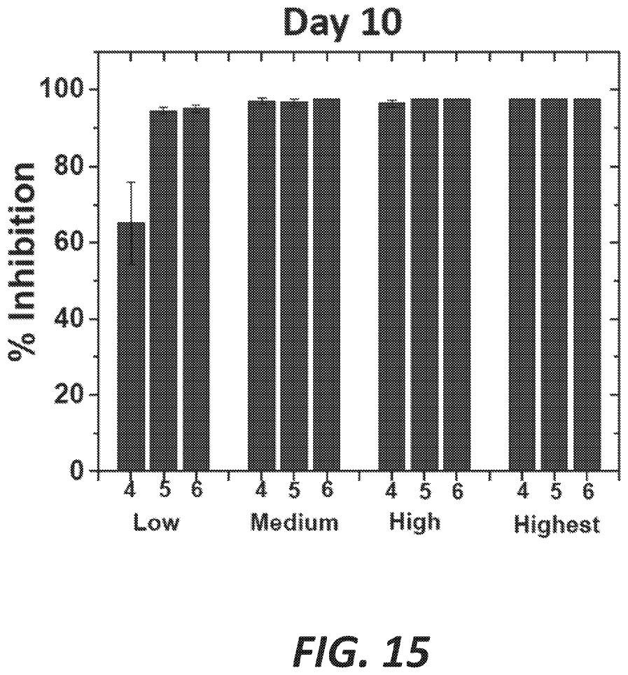

These results are shown in FIG. 15. As shown in FIG. 15, formulations including fungicide concentration of 5 ppm and above have a fungal grow inhibition percentage that is greater than 95%.

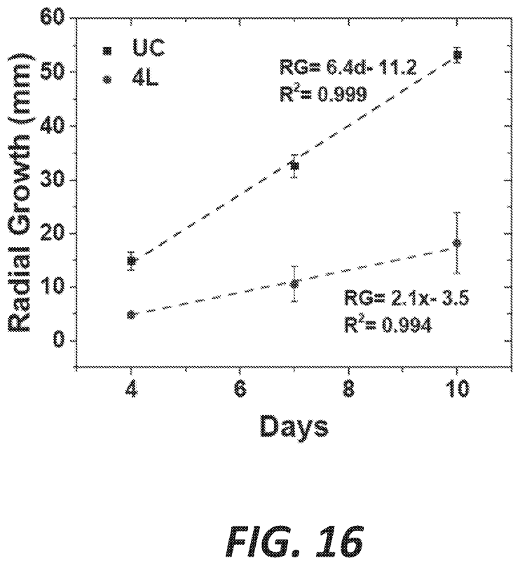

FIG. 16 shows a plot of the radial growth for CDA+FP (the CDA particles with fluopyram) at a fluopyram concentration of 1 ppm (“4L”) compared to the untreated control (“UC”).

The foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

1. A method of treating a plant, the method comprising:
applying a suspension to a surface of the plant, the suspension comprising:
an aqueous medium; and
a plurality of particles dispersed throughout the aqueous medium, wherein each particle in the plurality of particles includes polymeric carrier material and active ingredient dispersed throughout the particle.

2. The method according to claim 1, wherein the polymeric carrier material degrades at least 90% in two years.

3. The method according to claim 1, wherein the polymeric carrier material includes a cellulose ester.

4. The method according to claim 3, wherein the cellulose ester has a degree of substitution from 1 to 3.

5. The method according to claim 3, wherein the cellulose ester has a degree of substitution from 2.0 to 2.85.

6. The method according to claim 3, wherein the polymeric carrier material comprises cellulose acetate, cellulose diacetate, cellulose acetate propionate, cellulose acetate butyrate, or a combination thereof.

7. The method according to claim 1, wherein the active ingredient comprises an insecticide, a fungicide, a pesticide, or a combination thereof.

8. The method according to claim 7, wherein the active ingredient comprises fluopyram.

9. The method according to claim 1, wherein the plurality of particles include, by weight, less than about 20% of polymeric carrier material.

10. The method according to claim 9, wherein the plurality of particles include, by weight, 0.1% to 10% of polymeric carrier material

11. The method according to claim 1, wherein the plurality of particles have an average diameter of 25 nm to 5 μm.

12. The method according to claim 11, wherein the plurality of particles have an average diameter of 100 nm to 1 μm.

13. The method according to claim 1, wherein the active ingredient can be released at a continuous rate of 40-68% over a period of 24 hours.

14. The method according to claim 1, further comprising no more than 1% by volume organic solvent.

15. The method according to claim 1, wherein the plurality of particles adhere at least 40% of an initial amount after being subjected to 5 min of continuous water flow.

16. The method according to claim 1, wherein the plurality of particles further comprise 0.005 wt % to 2 wt % surfactant.

17. A method of making a suspension, the method comprising:
adding polymer material to an organic solvent such that the polymer material is present in the organic solvent at a concentration less than 20 wt. %;
adding an active ingredient to the organic solvent, the active ingredient being one of: an insecticide, a fungicide, and a pesticide;
agitating the organic solvent with the polymer material and the active ingredient, thereby generating an organic solvent mixture;
adding aqueous media to the organic solvent mixture, thereby generating particles including:
the polymer material dispersed throughout each particle; and
the active ingredient dispersed throughout each particle; and
removing the organic solvent, thereby generating an aqueous suspension comprising no more than 5% by volume organic solvent.

18. The method according to claim 17, the aqueous suspension comprising no more than 1% by volume organic solvent.

19. The method according to claim 16, the polymer material being a cellulose ester.

20. The method according to claim 19, the plurality of particles including, by weight, less than 20% of polymer material.

21. The method according to claim 20, the polymer material being cellulose acetate with a degree of substitution of 1 to 3; and
the active ingredient being fluopyram.

22. The method according to claim 16, wherein the aqueous media is added to the organic solvent mixture in doses, each dose volume being no more than 1 wt % of an organic solvent mixture volume.
